(19) United States
(12) Patent Application Publication
(10) Pub. No.: US 2015/0252238 A1
(43) Pub. Date: Sep. 10, 2015

(54) HEAT CURABLE SILICONE RUBBER COMPOSITION

(71) Applicant: MOMENTIVE PERFORMANCE MATERIALS JAPAN LLC, Tokyo (JP)

(72) Inventors: Hideo Takahashi, Minato-ku (JP); Hiroyoshi Iijima, Minato-ku (JP); Hidefumi Tagai, Minato-ku (JP)

(73) Assignee: Momentive Performance Materials Japan LLC a corporation

(21) Appl. No.: 14/438,447

(22) PCT Filed: Nov. 1, 2013
(86) PCT No.: PCT/JP2013/079694

§ 371 Date: Apr. 24, 2015

(30) Foreign Application Priority Data
Nov. 5, 2012 (JP) 2012-243429

(51) Int. Cl. C09K 3/16; C08L 83/04

(52) U.S. Cl. CPC C09K 3/16; C08L 83/04

(57) ABSTRACT

The present invention provides a heat curable silicone rubber composition capable of obtaining a cured product having a good transparency and antistatic property. A heat curable silicone rubber composition includes: (A) 100 parts by mass of an organopolysiloxane, (B) 10 to 400 parts by mass of a silicone resin, (C) an organohydrogenpolysiloxane in an amount such that the number of the hydrogen atoms bonded to a silicon atom per one alkenyl group bonded to a. silicon atom in the component (A) and the component (B) is 1.0 to 10.0, (D) a silicone rubber base polymer containing a hydrosilylation reaction catalyst, and (E) 30 to 3000 ppm of an ionic liquid serving as an antistatic agent, wherein the ionic liquid of the component (E) is one in which a difference of a refractive index from a refractive index of a cured product of the silicone rubber base polymer is within the range of ±0.04.

### TECHNICAL FIELD

The present invention relates to a heat curable silicone rubber composition capable of obtaining a cured product having a high transparency and antistatic property and suitable for optical applications.

### BACKGROUND ART

Since a silicone rubber can give a cured product having a high transparency, the silicone rubber is used as a raw material for various uses such as optical applications. The use applications of sealing or protection of LED, lens, and the like are known as the optical applications.

There is a case where a silicone rubber is required to have antistatic property, depending on the applications. In such a case, there is known a heat curable silicone rubber in which an ionic liquid is blended as an antistatic agent (WO-A1 2009/084730).

In addition, in the case of the use for the optical applications and in the case where antistatic property is required, both of transparency and antistatic property are required to be provided at a high level. In WO-A1 2009/084730, there is no description of transparency at all.

### SUMMARY OF THE INVENTION

An object of the present invention is to provide a heat curable silicone rubber composition capable of obtaining a cured product provided with both transparency and antistatic property.

The present invention provides the following invention as a means for solving the problem.

A heat curable silicone rubber composition including:
(A) 100 parts by mass of an organopolysiloxane having an average polymerization degree of 50 to 10000 and containing at least two alkenyl groups bonded to a silicon atom in one molecule;
(B) 10 to 400 parts by mass of a silicone resin which includes units selected from R₃SiO1/2 unit (unit M), SiO4/2 unit (unit Q), R₂SiO2/2 unit (unit D), and RSiO3/2 unit (unit T) (where R is a monovalent hydrocarbon group having 1 to 6 carbon atoms and at least two in one molecule are alkenyl groups.) and in which a sum of the unit M, unit Q and unit T in the whole structural units is 80% by mole or more;
(C) an organohydrogenpolysiloxane containing at least two hydrogen atoms bonded to a silicon atom in one molecule, in an amount such that the number of the hydrogen atoms bonded to a silicon atom per one alkenyl group bonded to a silicon atom in the component (A) and the component (B) is 1.0 to 10.0;
(D) a hydrosilylation reaction catalyst, and
(E) 30 to 3000 ppm of an ionic liquid serving as an antistatic agent,
   wherein the ionic liquid of the component (E) is one in which a difference of a refractive index from a refractive index of a cured product formed of a base silicone rubber mixture of the components (A), (B), (C) and (D) is within the range of ±0.04.

Furthermore, the present invention provides a cured product of the above-mentioned heat curable silicone rubber composition.

The cured product obtained from the heat curable silicone rubber composition of the present invention has a high transparency and is excellent in antistatic property.

### DETAILED DESCRIPTION OF THE INVENTION

The heat curable silicone rubber composition of the present invention contains a silicone rubber base polymer including the components (A) to (D) and the component (E).

### <Component (A)>

The component (A) is an organopolysiloxane having an average polymerization degree of 50 to 10000 and including at least two alkenyl groups bonded to a silicon atom in one molecule.

A group bonded to silicon atom other than alkenyl group can include a monovalent hydrocarbon group.

Examples of the monovalent hydrocarbon group can include an alkyl group such as methyl, ethyl, propyl or butyl; an aryl group such as phenyl or tryl; a cycloalkyl group such as cyclohexyl; an aralkyl group such as benzyl or β-phenylethyl; or chrolomethyl, cyanoethyl or the like in which a part or the whole of hydrogen atoms bonded to carbon atoms of those groups is substituted by a halogen atom (excluding fluorine atom), cyano group and the like, and methyl is preferable.

The alkenyl group bonded to silicon atom includes vinyl, allyl, and the like, and vinyl is preferable.

The organopolysiloxane of the component (A) is preferably a linear one, but may be one containing a branched structure as a part thereof.

An average polymerization degree of the organopolysiloxane of the component (A) is 50 to 10000, preferably 200 to 8000, and more preferably 500 to 1500.

### <Component (B)>

The component (B) is a silicone resin including units selected from the unit M, the unit Q, the unit D, and the unit T, where R is a monovalent hydrocarbon group having 1 to 6 carbon atoms and at least two in one molecule are alkenyl groups, and a sum of the unit M, unit Q and unit T in the whole structural units is 80% by mole or more.

The unit M, the unit Q, the unit D and the unit T are as follows.

Unit M: R₃SiO_{1/2} unit
Unit Q: SiO_{4/2} unit
Unit D: R₂SiO_{2/2} unit
Unit T: RSiO_{3/2} unit

R in each unit is a monovalent hydrocarbon group having 1 to 6 carbon atoms and preferably methyl group or phenyl group.

The sum of the unit M, unit Q and unit T in the whole structural units is 806 by mole or more, it is preferable that the sum of the unit M and unit Q in the whole structural units is 80% by mole or more.

Examples of the silicone resin of the component (B) can include a copolymer of vinyldimethylsiloxy group and the unit Q, a copolymer of vinyldimethylsiloxy group•trimethylsiloxy group and the unit Q, a copolymer of vinyldimethylsiloxy group•dimethylsiloxane unit and the unit Q, a copolymer of vinyldimethylsiloxy group•phenylsilsesquioxane unit and the unit Q, a copolymer of vinyldimethylsiloxy group•dimethylsiloxane unit•phenylsilsesquioxane unit and the unit Q, a copolymer of trimethylsiloxy group•vinylmethylsiloxane unit and the unit Q, and the like.

The content of the component (B) in the composition is 10 to 400 parts by mass relative to 100 parts by mass of the component (A), preferably 10 to 150 parts by mass, and more preferably 20 to 100 parts by mass.

### <Component (C)>

The component (C) is an organohydrogenpolysiloxane containing at least two hydrogen atoms bonded to a silicon atom in one molecule. The component (C) may be any one of linear, branched-chain or circular.

Examples of the component (C) can include a diorganopolysiloxane blocked with dimethylhydrogensilyl group, a copolymer of dimethylsiloxane unit and methylhydrogensiloxane unit and end trimethylsiloxane unit, a low-viscosity fluid of dimethylhydrogensiloxane unit and SiO₂ unit, 1,3,5,7-tetrahydrogen-1,3,5,7-tetramethylcyclotetrasiloxane, 1-propyl-3,5,7-trihydrogen-1,3,5,7-tetramethylcyclotetrasiloxane, 1,5-dihydrogen-3,7-dihexyl-1,3,5,7-tetramethylcyclotetrasiloxane, and the like.

The content of the component (C) in the composition is an amount such that the number of the hydrogen atoms bonded to a silicon atom per one alkenyl group bonded to a silicon atom in the component (A) and the component (B) is 1.0 to 10.0, preferably 1.0 to 5.0.

### <Component (D)>

A platinum element, a platinum compound, and a platinum complex can be used as the hydrosilylation reaction catalyst as the component (D), and specific examples thereof can include a platinic acid chloride such as platinic primary acid chloride or platinic secondary acid chloride; a platinum—based complex such as a complex of a platinic acid chloride with an alcohol compound, aldehyde compound, ether compound or various olefins; a platinum-vinylsiloxane complex, and the like.

The content of the component (D) in the composition is preferably 0.1 to 200 ppm as a platinum atom relative to the component (A), more preferably 1 to 50 ppm.

### <Component (E)>

The component (E) is an ionic liquid serving as an antistatic agent, and is a component in which a difference of a refractive index from a refractive index formed of a molded article of a base silicone rubber mixture of the components (A) to (D) is within the range of ±0.04. Furthermore, the component having a difference of the refractive indexes being within the range of ±0.02 is more preferable.

The ionic liquid of the component (E) is preferably a liquid at normal temperature (23° C.), and may be a liquid at temperature higher than the above-mentioned temperature. In addition, the ionic liquid is preferable to be poorly water-soluble or water-insoluble.

Furthermore, from the viewpoint of solubility in water, the ionic liquid of the component (E) is preferably an ionic liquid having poor water-solubility or water-insolubility with respect to the solubility in water. Note that, at normal temperature, an ionic liquid easily dissolved in water when water and the liquid are mixed in equal amounts is defined as being easily water-soluble, whereas the liquid phase-separated when being allowed to stand after mixing is defined as being water-insoluble, and the liquid becoming white turbid and not dissolved is defined as being poorly water-soluble.

The ionic liquid described above includes a cation and an anion.

Examples of the anion are an alkyl sulfate-based anion, a tosylate anion, a sulfonate-based anion, bis (trifluoromethanesulfonyl) imide anion, bis (fluorosulfonyl) imide anion, hexafluorophosphate anion, tetrafluoroborate anion, a halide anion, and the like.

Examples of the alkyl sulfate anion are methyl sulfate anion, ethyl sulfate anion, octyl sulfate anion, 2-(2-methoxyethoxy) ethyl sulfate, and the like. Examples of the sulfonate-based anion are methanesulfonate anion, trifluoromethanesulfonate anion, and the like. Examples of the halide anion are chloride anion, bromide anion, iodide anion, and the like.

Among them, from the viewpoint of being capable of imparting the antistatic property without impairing the excellent properties of the silicone rubber, the ionic liquid having bis (trifluoromethanesulfonyl) imide anion or bis (fluorosulfonyl) imide anion is preferable.

In addition, examples of the cation component of the ionic liquid of the component (E) are an imidazolium-based cation, a pyrrolidinium-based cation, a pyridinium-based cation, an ammonium -based cation, a phosphonium-based cation, a sulfonium-based cation, and the like. Particularly in the present invention, preferable are the imidazolium-based cation, the pyrrolidinium-based cation, the pyridinium-based cation, the ammonium-based cation.

Furthermore, it is possible to use the ionic liquid having at least one alkenyl group as the cation component. The component (B) including such a cation component is particularly preferable because of being able to stay for a long time within the silicone rubber composition.

Here, examples of the alkenyl group are a aliphatic unsaturated hydrocarbon group such as vinyl, allyl, methylvinyl, propenyl, butenyl, pentenyl or hexenyl; a cyclic unsaturated hydrocarbon group such as cyclopropenyl, cyclobutenyl, cyclopentenyl or cyclohexenyl; methacryl group, and the like. Among them, vinyl group or allyl group is preferable.

Examples of the pyrrolidinium-based cation are 1-butylmethylpyrrolidinium cation, 1-methyl-propylpyrrolidinium cation and the like. Examples of the pyridinium-based cation are 3-methyl-1-propylpyridinium cation, N-butyl-3-methylpyridinium cation, 1-methyl-1-propylpyridinium cation and the like. Examples of the ammonium-based cation are diallyldimethylammonium cation, methyltrioctylammonium cation and the like. Examples of the imidazolium-based cation are 1-butyl-3-methylimidazolium cation, 1,2-dimethyl-3-propylimidazolium cation, 1-ethyl-3-methylimidazolium cation, 1-vinylimidazolium cation, 1-allylimidazolium cation, 1-allyl-3-methylimidazolium cation and the like.

Preferable examples of the ionic liquid of the component (E) are one selected from the followings.
1-butyl-1-methylpyrrolidinium•bis-(trifluoromethanesulfonyl)imide,
1-ethyl-3-methylimidazolium•bis(fluorosulfonyl)imide,
1-butyl-3-methylpyridinium•bis-(trifluoromethanesulfonyl)imide,
diallyldimethylammonium-bis(trifluoromethanesulfonyl)-imide,
1-butyl-3-methylpyridinium•bis(fluorosulfonyl)imide,
1-ethyl-3-methylpyridinium•bis(fluorosulfonyl)imide,
1-ethyl -3-methylimidazolium•bis-(trifluoromethanesulfonyl) imide,
1-methyl-1-propylpyrrolidinium•bis(fluorosulfonyl)-imide,
1-ethyl-3-methylimidazolium•bis(fluorosulfonyl)imide,
methyltrioctylammonium•bis(trifluoromethanesulfonyl)-imide,
tributylmethylammonium•bis(trifluoromethanesulfonyl)-imide.

In order to impart, at a high level, transparency and antistatic property to the cured product obtained from the composition, the content of the component (E) in the composition relative to the mass of the silicone rubber base polymer containing the components (A) to (D) is 30 to 3000 ppm, preferably 40 to 2000 ppm, more preferably 50 to 1500 ppm.

As the other components, there can be used a reaction inhibitor for properly regulating a pot life by the control of the hydrosililation, a metal oxide as a heat resistance improver, a flame retardant aid, an antistatic agent other than the component (E), a processing aid, and the like.

Furthermore, an alkoxysilane-based compound containing an alkoxysilyl group, a silane coupling agent, a titanium-based or zirconium-based condensation catalyst, and the like can also be blended as a cross-linking aid.

The composition of the present invention can be obtained by uniformly mixing the above-mentioned components. In this mixing, a mixing machine usually used for a general silicone rubber blending can be used, and for example, a universal kneader, a planetary mixer, Banbury mixer, a gate mixer, Shinagawa mixer, a pressurizing mixer, a three-roll, and a twin-roll can be used.

According to the composition of the present invention, the composition in which the total light transmittance at 600 nm of a sheet formed of the cured product and having a thickness of 12 mm is larger than 85% is preferable, and the composition in which the total light transmittance at 600 nm of a sheet formed of the cured product and having a thickness of 2 mm is larger than 93% is more preferable.

The composition of the present invention can be used as a manufacturing raw material for various optical applications, and can include LED lens and the like.

### EXAMPLE

The following Examples describe the working of the present invention are explained. The Examples describe exemplification of the present invention, and the present invention is not limited thereby.

### Example and Comparative Example

The organopolysiloxane of the component (A) and the silicone resin of the component (B) shown in Table 1 were mixed by using a universal kneader (mixing and stirring machine 5DMV-α manufactured by DALTON).

At that time, in order to disperse the component (B) into the component (A), the component (B) was mixed in the form of 60% (by mass) xylene solution so that the amount of the component (B) was the blending amount shown in Table 1. After mixing, xylene contained in the mixture was distilled off under 140° C./667 Pa {5 mmHg}.

Then, after cooling to normal temperature (20 to 25° C.), the hydrosilylation catalyst of the component (D), 1-ethynyl-1-cyclohexanol of the reaction inhibitor, and the organohydrogensiloxane of the component (C) were mixed.

Finally, the additives for imparting the antistatic property such as the ionic liquid of the component (E) or an ionic substance as a comparative material were mixed and thus the silicone rubber composition shown in Table 1 was prepared. The measurements shown in Table 1 were carried out with respect to the compositions obtained.

Details of the respective components and units shown in Table 1 are as follows.

### (Unit M)

Unit M: (CH₃)₃SiO_{1/2}—
Unit MH: (CH₃)₂HSiO_{1/2}—
Unit Mv: (CH₃)₂ (CH₂═CH) SiO_{1/2}—

### (Unit D)

Unit D: —(CH₃)₂SiO—
Unit DH: —(CH₃)HSiO—
Unit Dv: —(CH₃)(CH₂═CH)SiO—
Unit Dff: —(C₆H₅)₂SiO—

### (Unit T)

Unit Tf: C₆H₅SiO_{3/2} (trifunctionality)

### (Unit Q)

Unit Q: SiO_{4/2} (tetrafunctionality)

### <Component (A) >

(A-1): Dimethylpolysiloxane blocked at the both ends with dimethylvinylsiloxy groups and having an average polymerization degree of 940
(A-2): Linear polymethylvinylphenylsiloxane blocked at the both ends with dimethylvinylsiloxy groups, having 16% of the unit Dff and residue of the unit D, and having a polymerization degree of 200 at 23° C.

### <Component (B)>

Polymethylvinylsiloxane resin including the unit M, the unit My and the unit Q, and represented by molar unit ratio of M₅MvQ₈.

### <Component (C)>

Polymethylhydrogensiloxane represented by M^{H}₈Q₄ having an average molecular weight of 800

### <Component (D)>

Platinum-vinylsiloxane complex having a platinum content of 2% by mass

### <Others>

Reaction inhibitor: 1-Ethyl-1-cyclohexanol

### <Component (E)>

Ionic liquid 1: 1-Butyl-1-methylpyrrolidinium·bis-(trifluoromethanesulfonyl)imide, refractive index 1.423

Ionic liquid 2: 1-Ethyl-3-methylimidazolium•bis-(fluorosulfonyl)imide, refractive index 1.423

Ionic liquid 3: 1-Butyl-3-methylpyridinium·bis-(trifluoromethanesulfonyl)imide, refractive index 1.446

Ionic liquid 4: Diallyldimethylammonium·bis-(trifluoromethanesulfonyl)imide, refractive index 1.425

Ionic liquid 5: 1-Butyl-3-methylpyridinium•bis-(fluorosulfonyl)imide, refractive index 1.459

Ionic liquid 6: 1-Ethyl-3-methylpyridinium•bis-(fluorosulfonyl)imide, refractive index 1.472

Ionic liquid 7: 1-Ethyl-3-methylimidazolium•bis-(trifluoromethanesulfonyl)imide, refractive index 1.423

Ionic liquid 8: 1-Methyl-1-propylpyrrolidinium•bis-(fluorosulfonyl)imide, refractive index 1.443

Ionic liquid 9: 1-Ethyl-3-methylimidazolium•bis-(fluorosulfonyl)imide, refractive index 1.448

Ionic liquid 10: Methyltrioctylammonium•bis-(fluorosulfonyl)imide, refractive index 1.438

Li.TFSI 50% aqueous solution: Litium•bis-(trifluoromethanesulfonyl)imide, refractive index 1.355

### (Production Method of Sheet)

After defoaming each component shown in Table 1 under reduced pressure and then casting the obtained compositions into a die, press-molding was performed at 150° C. for 10 minutes to thereby give molded articles of the silicone rubber composition having a thickness of 2 mm for measuring a volume resistivity, and having thicknesses of 2 mm and 12 mm for measuring a total light transmittance and a HAZE.

(Refractive index: refractive indexes of a cured product of the base polymer mixture including the components (A) to (D), and an ionic liquid)

A refractive index was measured by using Abbe's refractometer ATAGOT1.

A test piece was obtained by placing a base polymer mixture including the components (A) to (D) on a smooth metal plate heated to 100° C. or more, by thinly stretching in the form of thin film having a thickness of 0.1 mm or less with a spatula and the like, and by heating to be cured.

### [Charged Voltage Half-Life]

After a test piece was charged by 6 KV corona discharge, the time (second) when a charged voltage is reduced by half was measured through the use of a Static Honestmeter H-0110 manufactured by Shishido Electrostatic, Ltd.

### (Total Light Transmittance)

The total light transmittance at 600 nm was measured by spectrophotometer CM-3500d manufactured by KONICA MINOLTA (thicknesses of test piece to be measured 2 mm and 12 mm).

### (HAZE)

The measurement was carried out in accordance with JIS K 7105 byusing HAZE METER NDH5000 manufactured by NIPPON DENSHOKU INDUDTRIES Co., LTD.

(thicknesses of test piece to be measured 2 mm and 12 mm)

TABLE 1

| | | EXAMPLE | | | | | | |
|---|---|---|---|---|---|---|---|---|
| | | 1 | 2 | 3 | 4 | 8 | 9 | 5 |
| (A) | (A-1) (parts by mass) | 100 | 100 | 100 | 100 | | | 100 |
| | (A-2) (parts by mass) | | | | | 100 | 100 | |
| (B) (parts by mass) | | 45 | 45 | 45 | 45 | 45 | 45 | 45 |
| (C) (parts by mass) | | 10 | 10 | 10 | 10 | 10 | 10 | 10 |
| (D) (parts by mass) | | 0.02 | 0.02 | 0.02 | 0.02 | 0.02 | 0.02 | 0.02 |
| Amount of platinum metal to component (A) | | 4 | 4 | 4 | 4 | 4 | 4 | 4 |
| (ppm) | | | | | | | | |
| Reaction inhibitor (parts by mass) | | 0.4 | 0.4 | 0.4 | 0.4 | 0.4 | 0.4 | 0.4 |
| (E) | Ionic liquid 1 (ppm) | 1000 | | | | | | |
| | Ionic liquid 2 (ppm) | | 1000 | | | | | |
| | Ionic liquid 3 (ppm) | | | 1000 | | | | |
| | Ionic liquid 4 (ppm) | | | | 1000 | | | |
| | Ionic liquid 5 (ppm) | | | | | 1000 | | |
| | Ionic liquid 6 (ppm) | | | | | | 1000 | |
| | Ionic liquid 7 (ppm) | | | | | | | 1000 |
| | Ionic liquid 8 (ppm) | | | | | | | |
| | Ionic liquid 9 (ppm) | | | | | | | |
| | Ionic liquid 10 (ppm) | | | | | | | |
| | Li.TFSI 50% aq | | | | | | | |
| Refractive index of base silicone rubber mixture | | 409 | 1.409 | 1.409 | 1.409 | 1.469 | 1.469 | 1.409 |
| Refractive index of component (E) | | 1.423 | 1.423 | 1.446 | 1.425 | 1.459 | 1.472 | 1.423 |
| Difference of refractive indexes | | 0.014 | 0.014 | 0.037 | 0.016 | 0.010 | 0.003 | 0.014 |
| Charged Voltage Half-Life, sec. | | 0.1 | 0.2 | 0.1 | 0.1 | 0.7 | 0.2 | 0.3 |
| Transmittance (%), thickness of 12 mm | | 93 | 93 | 89 | 93 | 94 | 94 | 93 |
| HAZE (%), thickness of 12 mm | | 14 | 13 | 67 | 13 | 5 | 4 | 12 |
| Transmittance (%), thickness of 2 mm | | 94.0 | 94.0 | 93.8 | 94.1 | 94.0 | 94.0 | 94.1 |
| HAZE (%), thickness of 2 mm | | 3 | 3 | 14 | 4 | 2 | 2 | 2 |
| | | EXAMPLE | | | | | | |
| | | 6 | 7 | 8 | 9 | 10 | 11 | 12 |
| (A) | (A-1) (parts by mass) | 100 | 100 | 100 | 100 | 100 | 100 | 100 |
| | (A-2) (parts by mass) | | | | | | | |
| (B) (parts by mass) | | 45 | 45 | 45 | 45 | 45 | 10 | 400 |
| (C) (parts by mass) | | 10 | 10 | 10 | 10 | 10 | 10 | 10 |
| (D) (parts by mass) | | 0.02 | 0.02 | 0.02 | 0.02 | 0.02 | 0.02 | 0.02 |
| Amount of platinum metal to component (A) | | 4 | 4 | 4 | 4 | 4 | 4 | 4 |
| (ppm) | | | | | | | | |
| Reaction inhibitor (parts by mass) | | 0.4 | 0.4 | 0.4 | 0.4 | 0.4 | 0.4 | 0.4 |
| (E) | Ionic liquid 1 (ppm) | | | | | | | |
| | Ionic liquid 2 (ppm) | | | | | | | |
| | Ionic liquid 3 (ppm) | | | | | | | |
| | Ionic liquid 4 (ppm) | | | | | | | |
| | Ionic liquid 5 (ppm) | | | | | | | |
| | Ionic liquid 6 (ppm) | | | | | | | |
| | Ionic liquid 7 (ppm) | | | | | | | |
| | Ionic liquid 8 (ppm) | 1000 | | | | | | |
| | Ionic liquid 9 (ppm) | | 1000 | | | | | |
| | Ionic liquid 10 (ppm) | | | 1000 | 50 | 3000 | 700 | 2700 |
| | Li.TFSI 50% aq | | | | | | | |

| | | | | | | | |
|---|---|---|---|---|---|---|---|
| Refractive index of base silicone rubber mixture | 1.409 | 1.409 | 1.409 | 1.409 | 1.409 | 1.406 | 1.417 |
| Refractive index of component (E) | 1.443 | 1.448 | 1.438 | 1.438 | 1.438 | 1.438 | 1.438 |
| Difference of refractive indexes | 0.034 | 0.039 | 0.029 | 0.029 | 0.029 | 0.032 | 0.021 |
| Charged Voltage Half-Life, sec. | 0.3 | 0.2 | 0.5 | 4.2 | 0.1 | 0.6 | 0.5 |
| Transmittance (%), thickness of 12 mm | 89 | 89 | 91 | 93 | 85 | 91 | 85 |
| HAZE (%), thickness of 12 mm | 56 | 69 | 10 | 13 | 77 | 10 | 77 |
| Transmittance (%), thickness of 2 mm | 94.0 | 93.7 | 93.5 | 94.1 | 93.2 | 93.4 | 93.0 |
| HAZE (%), thickness of 2 mm | 12 | 17 | 16 | 2 | 20 | 16 | 20 |

| | | COMPARATIVE EXAMPLE | | | | |
|---|---|---|---|---|---|---|
| | | 1 | 2 | 3 | 4 | 5 |
| (A) | (A-1) (parts by mass) | 100 | | 100 | 100 | 100 |
| | (A-2) (parts by mass) | | 100 | | | |
| (B) (parts by mass) | | 45 | 45 | 45 | 45 | 45 |
| (C) (parts by mass) | | 10 | 10 | 10 | 10 | 10 |
| (D) (parts by mass) | | 0.02 | 0.02 | 0.02 | 0.02 | 0.02 |
| Amount of platinum metal to component (A) (ppm) | | 4 | 4 | 4 | 4 | 4 |
| Reaction inhibitor (parts by mass) | | 0.4 | 0.4 | 0.4 | 0.4 | 0.4 |
| (E) | Ionic liquid 1 (ppm) | | 1000 | | | |
| | Ionic liquid 2 (ppm) | | | | | |
| | Ionic liquid 3 (ppm) | | | | | |
| | Ionic liquid 4 (ppm) | | | | | |
| | Ionic liquid 5 (ppm) | | | 1000 | | |
| | Ionic liquid 6 (ppm) | | | | 1000 | |
| | Ionic liquid 7 (ppm) | | | | | |
| | Ionic liquid 8 (ppm) | | | | | |
| | Ionic liquid 9 (ppm) | | | | | |
| | Ionic liquid 10 (ppm) | | | | | |
| | Li.TFSI 50% aq | | | | | 1000 |

| | | | | | |
|---|---|---|---|---|---|
| Refractive index of base silicone rubber mixture | 1.409 | 1.469 | 1.409 | 1.409 | 1.409 |
| Refractive index of component (E) | — | 1.423 | 1.459 | 1.472 | 1.355 |
| Difference of refractive indexes | 0 | 0.046 | 0.050 | 0.063 | 0.054 |
| Charged Voltage Half-Life, sec. | Not attenuated | 0.2 | 0.9 | 0.8 | 0.2 |
| Transmittance (%), thickness of 12 mm | 93 | 84 | 82 | 79 | 56 |
| HAZE (%), thickness of 12 mm | 4 | 80 | 89 | 94 | 98 |
| Transmittance (%), thickness of 2 mm | 94.2 | 93.0 | 93.0 | 93.1 | 93.1 |
| HAZE (%), thickness of 2 mm | 1 | 20 | 22 | 38 | 23 |

The composition of the present invention can be used as a manufacturing raw material for various optical uses including LED lens.

1. A heat curable silicone rubber composition comprising:
(A) 100 parts by mass of an organopolysiloxane having an average polymerization degree of 50 to 10000 and containing at least two alkenyl groups bonded to a silicon atom in one molecule;
(B) 10 to 400 parts by mass of a silicone resin which includes units selected from R₃SiO1/2 unit (unit M), SiO4/2 unit (unit Q), R₂SiO2/2 unit (unit D), and RSiO3/2 unit (unit T) (where R is a monovalent hydrocarbon group having 1 to 6 carbon atoms and at least two in one molecule are alkenyl groups.) and in which a sum of the unit M, unit Q and unit T in the whole structural units is 80% by mole or more;
(C) an organohydrogenpolysiloxane containing at least two hydrogen atoms bonded to a silicon atom in one molecule, in an amount such that the number of the hydrogen atoms bonded to a silicon atom per one alkenyl group bonded to a silicon atom in the component (A) and the component (B) is 1.0 to 10.0;
(D) a hydrosilylation reaction catalyst, and
(E) 30 to 3000 ppm of an ionic liquid serving as an antistatic agent,
wherein the ionic liquid of the component (E) is one in which a difference of a refractive index from a refractive index of a cured product formed of a base silicone rubber mixture of the components (A), (B), (C) and (D) is within a range of ±0.04.

2. The heat curable silicone rubber composition according to claim 1, wherein the ionic liquid of the component (E) is a liquid at a normal temperature (23° C.).

3. The heat curable silicone rubber composition according to claim 1, wherein the ionic liquid of the component (E) has bis(trifluoromethanesulfonyl)imide or bis(fluoorosulfonyl)imide, as an anion component.

4. The heat curable silicone rubber composition according to claim 1, wherein the ionic liquid of the component (E) has an imidazolium-based cation, a pyrrolidinium-based cation, a pyridinium-based cation, or an ammonium-based cation, as a cation component.

5. The heat curable silicone rubber composition according to claim 1, wherein the component (E) is one selected from
1-butyl-1-methylpyrrolidinium•bis-(trifluoromethanesulfonyl)imide,
1-ethyl-3-methylimidazolium•bis(fluorosulfonyl)imide,
1-butyl-3-methylpyridinium•bis-(trifluoromethanesulfonyl)imide,
diallyldimethylammonium•bis(trifluoromethanesulfonyl)imide,
1-butyl-3-methylpyridinium•bis(fluorosulfonyl)imide,
1-ethyl-3-methylpyridinium•bis(fluorosulfonyl)imide,
1-ethyl-3-methylimidazolium•bis-(trifluoromethanesulfonyl)imide,
1-methyl-1-propylpyrrolidinium•bis(fluorosulfonyl)imide,
1-ethyl-3-methylimidazolium•bis(fluorosulfonyl)imide,
methyltrioctylammonium•bis(trifluoromethanesulfonyl)imide, and
tributylmethylammonium•bis(trifluoromethanesulfonyl)imide.

6. The heat curable silicone rubber composition according to claim 1, wherein a total light transmittance at 600 nm of a sheet formed of a cured product of the composition and having a thickness of 12 mm is larger than 85%.

7. That heat curable silicone rubber composition according to claim 1, wherein a total light transmittance at 600 nm of a sheet formed of a cured product of the composition and having a thickness of 2 mm is larger than 93%.

8. A cured product of the heat curable silicone rubber composition according to claim 1.

9. The cured product according to claim 8, wherein a total light transmittance at 600 nm of a sheet having a thickness of 12 mm is larger than 85%.

10. The cured product according to claim 8, wherein a total light transmittance at 600 nm of a sheet having a thickness of 2 mm is larger than 93%.
